(19) United States
(12) Patent Application Publication
(10) Pub. No.: US 2026/0180362 A1
(43) Pub. Date: Jun. 25, 2026

(54) JOHNSON AMBIENT ENERGY CONVERTER

(71) Applicant: Lonnie G. Johnson, Atlanta, GA (US)

(72) Inventor: Lonnie G. Johnson, Atlanta, GA (US)

(21) Appl. No.: 19/428,729

(22) Filed: Dec. 22, 2025

Related U.S. Application Data
(60) Provisional application No. 63/737,892, filed on Dec. 23, 2024.

(51) Int. Cl. H02J 50/00; H02N 11/00

(52) U.S. Cl. CPC H02J 50/001; H02N 11/002

(57) ABSTRACT

An ambient energy converter derives energy from variations in ambient temperature and humidity. The ambient energy converter includes a controller, a first chamber containing a first hygroscopic ionic solution and a second chamber containing a second ionic solution. Each chamber includes an electrochemically reactive electrode in contact with the solution therein. The chambers are separated by an ion conductive membrane that conducts an ion species of the solutions. The first solution is coupled to ambience and maintains water vapor pressure equilibrium with changes in ambient humidity. The process results in water condensing and evaporating into and out of the solution with increases and decreases in ambient humidity respectively. The second solution is sealed within a chamber and coupled to the hygroscopic solution by an ion conductive barrier. Water vapor condensing into or evaporating from the hygroscopic solution creates a concentration differential across the ion conductive barrier that generates electricity.

### CROSS REFERENCE TO RELATED APPLICATION

Applicant claims the benefit of U.S. Provisional Patent Application Ser. No. 63/737,892 filed Dec. 23, 2024 and entitled “Johnson Ambient Energy Convertor (JAEC), and is incorporated herein by reference in its entirety.

### BACKGROUND

Advanced electronics and Micro-Electromechanical Systems (MEMS) technologies have resulted in application-specific devices that require power levels that are significantly lower than prior devices. MEMS devices are very small electrical and mechanical devices built to scales comparable to ICs and, thus, can be significantly smaller than traditional sensors performing the same functions. Chip Scale Package (CSP) technology enables IC packages that are virtually the same size as the ICs contained within them, and Stacked Chip Scale Package (SCSP) technology enables the placement of multiple ICs in a single package. As a result, the demand for specialized integrated circuits (ICs) and power sources is surging exponentially.

Thin-film micro-batteries can be made in very small sizes that are compatible with MEMS devices; however, the capacity of these batteries is extremely limited. Thin film all glass, ceramic and metal batteries do not contain volatile liquid or polymer organic electrolyte. They offer very attractive performance properties, including long shelf life, long term stable power capability, no gassing, broad operating temperature range (−40° C. to 170° C. for pure lithium anodes and up to and beyond operating temperatures of 300° C. using active composite anodes). They are particularly suited for applications requiring long life under low-drain or open-circuit conditions. Even when high density energy storage capacity is achieved at the micro-power level, the amount of available energy remains limited. There remains a critical need for a practical, cost effective, power source that can harvest energy from its ambient environment.

Legacy batteries and capacitors do not have the characteristics required to meet the energy storage requirements of such small devices, especially for devices that may be employed in remote locations away from continuous recharge power sources. Reductions in power consumption is a major area of focus for any MEMS device design effort. Power consumption is directly related to the size of the battery required, and the battery often ends up being the largest component in the device. Higher device power consumption requires higher battery capacity, and higher battery capacity requires larger battery volume. Despite dramatic technological advances in MEMS and electronic circuits, most of the devices are still relatively large, primarily driven by the size of their power sources, particularly battery size. MEMS devices can use rechargeable batteries; however, the energy needed to charge batteries is often not available.

The solution to this challenge is to link such devices to an energy generation system that can provide essentially continuous recharging. A key requirement for any such technology is an ability to provide energy at any given time or location. Most existing techniques for harvesting energy are built around specific environments. For example, solar cells may be employed when adequate light is available to meet operational requirements of the system being powered. The requirement for light can limit the time of operation and even physical placement. Existing semiconductor type thermoelectric devices need a simultaneous temperature differential to function. To generate power operating on temperature changes in the environment, an insulated thermal mass of heat sink material which lags in temperature change relative to the environment is often used to create the required temperature differential. One side of the device is thermally coupled to the ambient temperature and the other to the thermal mass. Thus, two distinct temperatures can be applied across a thermal energy harvesting device simultaneously to harvest energy from the ambient environment, one would be the temperature of the thermal mass and the other would be the existing ambient temperature.

It is generally understood that it is difficult to create and maintain the required temperature difference for ambient energy harvesting devices, particularly for small or micro power devices. Parasitic heat conduction through the structure of the device tends to suppress temperature differences particularly under slow thermal transient conditions. In addition, the need to include a high heat capacity material and thermal insulation limits the minimum size that can be achieved by such a device.

U.S. Pat. No. 9,559,388 B2 discloses an electrochemical system configured to harvest heat energy for thermally regenerative electrochemical cycle. The invention uses an electrochemical cell with an electrode pair that have temperature coefficients which causes the cell's voltage to change significantly with changes in temperature. The cell is discharged at one temperature and recharged at another. The difference in the amount of energy needed for recharge when the voltage is low versus that provided when the voltage is high is stored for subsequent use. A limitation of the device is low power density and the need for energy storage of some of the discharge energy for use to recharge the cell to set up the next discharge.

U.S. Pat. No. 5,208,112 A discloses a thermally regenerated fuel cell wherein an acidic electrolyte is consumed producing salt solution during discharge at one temperature and then regenerated back into acid by heating to a second temperature. A limitation of this invention is the requirement for a temperature transient large enough to convert the salt electrolyte back into acid.

U.S. Pat. No. 10,305,149 B2 discloses an electrochemical stack direct heat to electricity generator for two cells having different thermal coefficients such that a cell one is discharged to cell two at one temperature where the voltage difference between the cells is low and discharged from cell two back to cell one when the voltage difference is high. The cell is similar to that shown in U.S. Pat. No. 9,559,388 B2. The difference in required energy is stored or consumed externally. However, U.S. Pat. No. 10,305,149 B2 includes a power management processor.

U.S. Pat. No. 6,686,076 discloses an electrochemical conversion system that uses two metal hydride beds separated by a membrane electrode assembly that produces voltage determined by the hydrogen pressure difference between the two beds. One bed is thermally stabilized whereas the other is exposed to ambient. The hydrogen pressure differential across the Membrane Electrode Assembly (MEA) varies with ambient temperature variations. As such, power is generated as hydrogen is cycled back and for the across the MEA under the imposed pressure differential.

U.S. Pat. No. 10,122,055 B2 discloses an ambient-heat engine that uses a membrane electrode assembly (MEA) to separate two metal hydride beds each storing hydrogen at a different pressure at a given temperature. Power is generated by discharging hydrogen from high pressure to low pressure at high temperature through the MEA when the voltage is high. The MEA is used to pump hydrogen from low pressure back to high pressure at low temperature when the voltage is low. The difference in required energy is used externally or stored for subsequent use.

U.S. Pat. No. 10,553,916 B2 discloses an ambient heat engine that generates power from ambient temperature transients. It includes two complementary electrochemical cells each consisting of a membrane electrode assembly (MEA) sandwiched between two metal hydride beds each storing hydrogen at a different pressure at a given temperature. One cell has a positive voltage temperature coefficient whereas the other cell has a negative voltage temperature coefficient. . . . Ambient temperature variation creates an alternating voltage differential whereby the cells generate output power during temperature increases as well as during temperature decreases. The controller extracts alternating current (AC) power from the cell pair. A limitation of the invention is low power density, complexity and the need to hermetically store hydrogen in a small device for an extended period of time.

U.S. Pat. No. 11,581,599 B2 discloses an ambient energy converter that operates on ambient humidity. A hygroscopic solution is used to electrochemically condense ambient water vapor through a proton conductive membrane electrode assembly. Counter balancing water vapor oxidation reduction reactions. Water is electrolyzed releasing oxygen to the environment at one electrode as the resulting protons are conducted through the membrane where they react with oxygen dissolved in the solution producing water at the other electrode. The power density is very limited because the 0.4 Volt activation voltage needed beyond the hydrogen-oxygen electrolyzing potential limits the voltage available to drive current from the cell.

U.S. Pat. No. 11,489,185 discloses a power generator that uses a hygroscopic, proton conductive membrane sandwiched between a pair of electrodes. The hygroscopic membrane has a different reaction potential for water vapor relative to the electrolyte's reaction potential with the liquid water. Power is generated between the electrodes with water vapor being electrolyzed at the electrode that is in contact with water vapor releasing oxygen and liquid water being reduced at the opposite electrode as protons conducted through the membrane react with dissolved oxygen in the liquid water. The power density is very limited because the 0.4 Volt activation voltage needed beyond the hydrogen-oxygen electrolyzing potential limits the voltage available to drive current from the cell.

U.S. patent application Ser. No. 17/893,638 discloses an ambient heat energy converter that includes a first hygroscopic electrode, a proton conductive membrane separator, a barrier membrane, and a second electrode. The barrier membrane allows protons to pass through but is a barrier to materials within the electrode that impart its hygroscopic properties. The membrane separator is formed of a material that has a higher affinity for liquid water when in contact with a solid or liquid interface relative to its affinity for water vapor. The difference in water phase affinity produces a voltage potential between the electrodes. The power density is very limited because the 0.4 Volt activation voltage needed beyond the hydrogen-oxygen electrolyzing potential limits the voltage available to drive current from the cell.

Other approaches which rely on kinetic energy, such as capturing vibrations cannot be used in non-physically dynamic applications or locations. Vibration driven piezoelectric driven energy harvesters provide power when physically coupled to a vibration source.

Thus, a need continues to exists for a device that produces power from energy that is freely available in the ambient environment and that can operate in essentially any location. A converter is needed wherein the entire converter maintains a state of equilibrium with its environment. A converter is needed that does not require an artificially created temperature differential using a heat sink and thermal insulation. The need exists for a converter that does not require active energy stimulation with associated location restrictions such as light for photovoltaic cells or vibration for piezoelectric converters. It is to these needs that the present invention is directed.

### BRIEF SUMMARY OF THE INVENTION

An ambient energy converter comprises an ion concentration cell that includes a first electrode, a first electrolyte solution, an ion conductive barrier electrolyte, a second electrolyte solution, and second electrode, the first electrode being in contact with the first electrolyte solution, the second electrode being in contact with the second electrolyte solution, the ion conductive barrier electrolyte having a transference number of substantially one, the first electrolyte solution being in contact with to the ion conductive barrier electrolyte, in contact with the first electrode, and in contact with ambient, the second electrolyte solution being in contact with the ion conductive barrier electrolyte oppositely disposed from the first electrolyte solution, in contact with to the second electrode, and isolated from ambient, the first electrolyte solution and the second electrolyte solution having at least one ion species in common, the barrier electrolyte being an ion conductor of the at least one ion species in common of the first electrolyte solution and the second electrolyte solution, the first electrolyte solution being hygroscopic and maintaining a water vapor pressure equilibrium with ambient by absorbing and releasing water vapor to ambient. With this construction, the harvesting device generating electrical power by electrochemical reactions between the first and second electrodes and the electrolyte solutions as the ion conductive barrier electrolyte conducts the at least one ion species in common back and forth between the first electrolyte solution and the second electrolyte solution to maintain ion concentration equilibrium between the first electrolyte solution and the second electrolyte solution as the first electrolyte solution absorbs and releases water vapor to and from ambient.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications. The reference numbering between drawing figures are not necessarily consistent.

FIG. 1 is a schematic view of an ambient energy converter that embodies principles of the present invention, shown coming to equilibrium with a decrease in ambient water vapor pressure whereby evaporation of water from the chamber generates electrical power.

FIG. 2 is a schematic view of the ambient energy converter of FIG. 1, showing the process for coming to equilibrium with power generation after an increase in ambient humidity whereby condensation of water into the chamber generates electrical power.

FIG. 3 is a graph showing representative data illustrating the random nature of ambient relative humidity variations.

FIG. 4 is a graph showing the relationship between ambient vapor pressure and humidity at selected temperatures.

FIG. 5 is a graph showing lithium chloride vapor pressure versus salt concentration at selected temperatures.

FIG. 6 is a graph showing ideal voltage levels for a range of lithium chloride salt solution concentration levels relative to a concentration of 0.2 miles/kg solution across an ion conductive membrane having a transference number (t_{c}) of 1.

FIG. 7A is a schematic side view of a structure for connecting an array of cells in series to generate power at useful voltage levels.

FIG. 7B is a schematic front view of a structure for connecting an array of cells in series to generate power at useful voltage levels.

FIG. 7C is a schematic cross-sectional view of a structure for connecting an array of cells in series to generate power at useful voltage levels.

FIG. 8A is a schematic side view of a concentration cell array mounted within a housing and the inclusion of interconnects to electrically connect the cells in series.

FIG. 8B is a schematic front view of a concentration cell array mounted within a housing and the inclusion of interconnects to electrically connect the cells in series.

FIG. 8C is cross-sectional view of a concentration cell array mounted within a housing and the inclusion of interconnects to electrically connect the cells in series.

FIG. 9A is a schematic side view of an interconnected concentration cell assembly mounted inside a housing with porous hydrophobic cover to couple the content of half of concentration each cell to ambience.

FIG. 9B is a schematic front view of an interconnected concentration cell assembly mounted inside a housing with porous hydrophobic cover to couple the content of half of concentration each cell to ambience.

FIG. 9C is cross-sectional view of an interconnected concentration cell assembly mounted inside a housing with porous hydrophobic cover to couple the content of half of concentration each cell to ambience.

### DETAILED DESCRIPTION

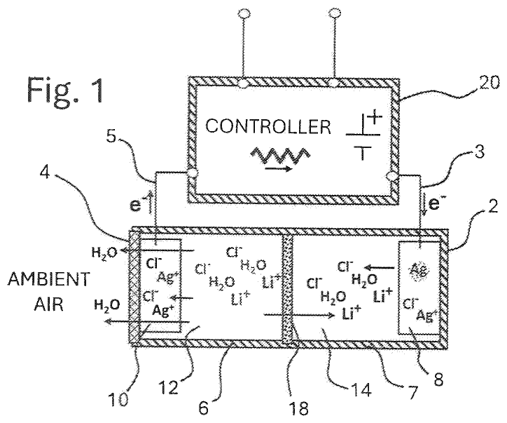

With reference next to the drawings, there is shown an ambient energy converter 2 embodying principles of the invention in a preferred form. The invention disclosed hereby derives operating energy from normal variations in ambient temperature and humidity. FIG. 1 illustrates a representative embodiment of the ambient energy converter 2, hereinafter referenced simply as converter 2, and a controller 20. Converter 2 is representative of a pair of chambers 6 and 7 separated by impermeable alkali metal conductive barrier electrolyte 18, hereinafter barrier electrolyte 18, to form an ion concentration cell 19. The first chamber 6 of the pair of chambers is exposed to ambient, ambient air, or ambience, whereas the second chamber 7 of the pair of chambers is hermetically sealed or isolated from ambient. A first electrode 10 and a first hygroscopic electrolyte solution 12 are contained within the first chamber 6 whereas second electrode 8 and second electrolyte solution 14 are contained within the second chamber 7. Preferably, the second electrolyte solution 14 is hygroscopic, but is not required to be so. For convenience of explanation, the second electrolyte solution 14 will be referenced hereinafter as second hygroscopic electrolyte solution 14. The second hygroscopic electrolyte solution 14 in the second chamber maintains an ion concentration balance as ions are conducted across separator 18. In this example the ion is lithium. In other examples the ions being conducted across the membrane may be calcium or some other material. Terminals 3 and 5 electrically connect controller 20 to first and second electrodes 10 and 8 respectively. The first hygroscopic electrolyte solution 12 is coupled or exposed to the surrounding ambient air by a porous hydrophobic membrane 4 which restrains first hygroscopic electrolyte solution 12 while enabling it to maintain water vapor pressure equilibrium with ambient humidity.

In this representative example, the hygroscopic electrolyte solution within chambers 6 and 7 is lithium chloride (LiCl) and both electrodes 8 and 10 are silver based and include silver chloride. Lithium is selected as the positive ion material because of the availability of high barrier alkali metal-ion conductive materials having an ion transference number (t_{c}) of substantially 1. Here, the transference number of approximately or substantially 1 means a transference number of 0.85 to 1.0. The term transference number means The transference number is the fraction of the total charge in the battery carried by the primary ion type. The real advantage is the use of a high barrier material such as an ion conductive ceramic that does not allow diffusion of salt or water from one side to the other and thereby prevents the main mechanism that causes self-discharge (coming to concentration equilibrium) with no power being generated. The important ions being conducted back and forth across the membrane are Lithium ions which are positive (Li⁺). The equation

$${t}_{+} = \frac{{i}_{+}}{{i}_{total}} \qquad [ 1 ]$$

is applicable. The electronic conductivity for ceramics is typically at least an order of magnitude lower than the ion conductivity.

Solid ceramic and glass barrier materials have the additional advantage of restricting self-discharge by limiting ion diffusion over the course of long duration daily temperature and humidity transients. Suitable example materials fall in the lithium super ionic conductor (LISICON) and sodium super ionic conductor (NASICON) categories and include representative materials such as lithium lanthanum zirconium oxide (LLZO), and lithium aluminum titanium phosphate.

FIG. 1 illustrates the process by which cell pair or chambers 6 and 7 comes to equilibrium with a decrease in ambient water vapor pressure whereby evaporation of water from chamber 6 generates electrical power. The assembly or ambient energy converter 2 functions as a concentration cell whereby the resulting concentration difference between hygroscopic electrolyte solution 12 and 14 produces a voltage differential across electrodes 8 and 10. A decrease in ambient humidity creates a condition where ambient water vapor pressure is lower than the vapor pressure of the hygroscopic electrolyte solution within chamber 6. With the first electrode 10 being negative and the second electrode 8 being positive. Under low ambient humidity, water evaporates from chamber 6 which creates a concentration differential between the hygroscopic electrolyte solutions 12 and 14. Driven by the concentration differential, electrons flow through controller 20 from first electrode 10 to second electrode 8 as silver chloride is reduced in first electrode 10 as chloride ions from the first hygroscopic electrolyte solution 12 react with silver therein. Simultaneously released lithium ions from first hygroscopic electrolyte solution 12 are conducted through solid conductive barrier electrolyte 18 into second hygroscopic electrolyte solution 14. Silver is reduced within second electrode 8 as chlorine ions are released balance the lithium ions entering the second hygroscopic electrolyte solution 14 through barrier electrolyte 18 to complete the reaction as electrons are routed to second electrode 8 through the controller 20.

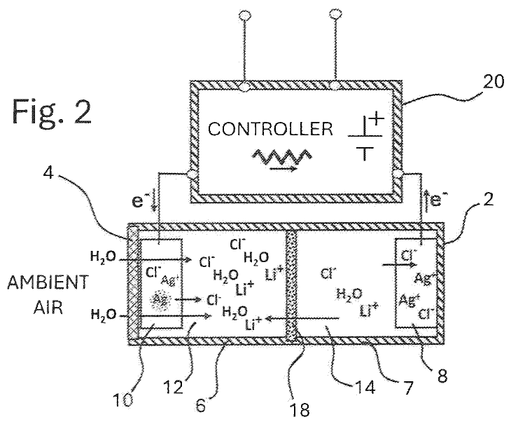

FIG. 2 illustrates the process for coming to equilibrium after an increase in ambient humidity. An increase in ambient water vapor pressure results in water vapor absorption through porous hydrophobic membrane 4 into the first hygroscopic electrolyte solution 12. The resulting concentration difference between the first hygroscopic electrolyte solution 12 and the second hygroscopic electrolyte solution 14 produces a voltage differential across second electrodes 8 and first electrode 10 with the second electrode 8 being negative and first electrode 10 being positive. Electrons flow through the controller 20 from the second electrode 8 to the first electrode 10 resulting in silver chloride being reduced in the second electrode 8 as chloride ions from second hygroscopic electrolyte solution 14 react with silver in second electrode 8 to produce silver chloride. Lithium ions simultaneously released by second hygroscopic electrolyte solution 14 are conducted from chamber 7 to chamber 6 through solid conductive barrier electrolyte 18 into the first hygroscopic electrolyte solution 12. Silver reduced within first electrode 10 as chlorine ions are released to balance the lithium ions entering the first hygroscopic electrolyte solution 12 through conductive barrier electrolyte 18. The reaction is complete as the associated electrons enter first electrode 10 from the controller 20.

The controller 20 is electrically coupled to the first and second electrodes 10 and 8 and includes sensors for monitoring the operating conditions ambient humidity, temperature, converter voltage and state of charge to extract power when predetermined criteria have been met. The controller 20 maintains the ambient energy converter 2 under essentially open circuit conditions and draws power only under preprogrammed conditions.

The net coulombic change (current flow) associated with a given change in concentration equilibrium is predictable. However, the voltage generated by the ambient energy converter 2 is maximum when the concentration differential between the first hygroscopic electrolyte solutions 12 and the second hygroscopic electrolyte solution 14 is maximum. If power is drawn continuously from the ambient energy converter 2 during humidity transients, then the average output voltage of the ambient energy converter 2 will be low because an essentially continuous discharge does not allow build up a concentration differential. By allowing the cell to store energy as a concentration differential and pulling energy from the ambient energy converter 2 under conditions of peak concentration differential (peak voltage) and storing it, the controller 20 maximizes performance of the ambient energy converter 2.

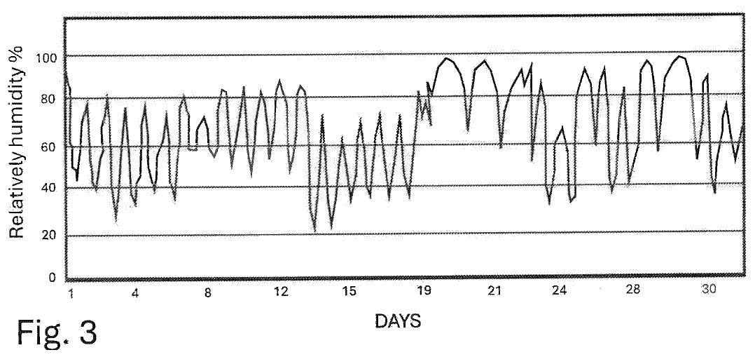

Referring next to FIG. 3, it shows representative data illustrating the random nature of ambient relative humidity variations. The data is for a randomly selected location for a period of 30 days. As can be seen from the chart, the variations are random in magnitude and random with respect to the time of day and cycle time. Such solar driven random variations are the source of energy that drives the invention disclosed hereby to generate electrical power. A representative daily change in magnitude of ambient humidity for the time and location at which the data in FIG. 3 was taken averages about 40%, generally transitioning between 40% RH to 80%.

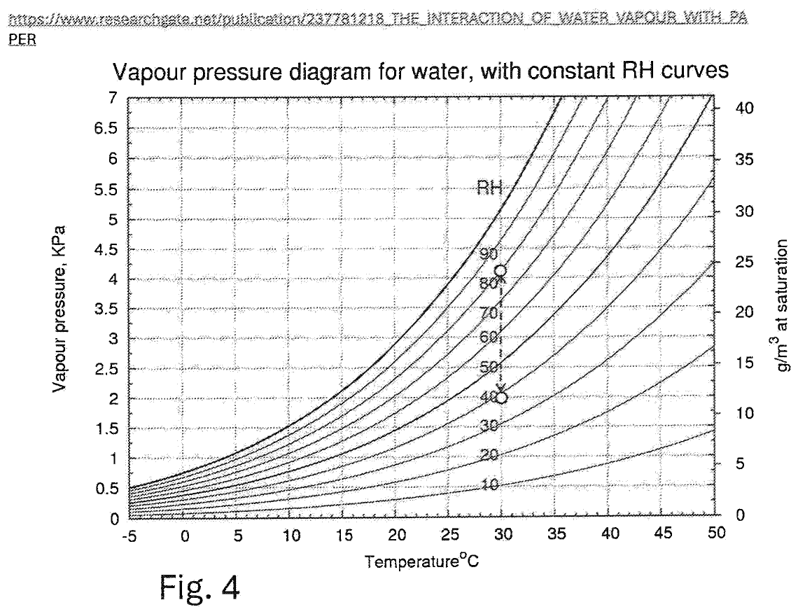

The electrical potential due to a concentration differential across the ion conductive membrane is determined by Nernst Equation 1, see “Energy Harvesting By Ambient Humidity Variation With Continuous Milliampere Current Output And Energy Storage”, by Yusuke Komazaki, et.al., Sustainable Energy Fuels, 2021, 5, 3570-3577, The Royal Society of Chemistry. The voltage is proportional to the natural logarithm of the ionic species activity ratio between the ambient and sealed chambers. The voltage is linear with respect to temperature and is a logarithmic function of the activity ratio.

$$Voc = \frac{2 {t}_{c} RT}{F} ln ( \frac{{a}_{a}}{{a}_{s}} ) \qquad Equation 1.$$

where V_{OC} is open circuit voltage, t_{c} is the transference number of the ion conductive membrane, R is the universal gas constant, Tis the cell temperature, Fis Faraday's constant, aₐ is the activity of the solution exposed to ambient and aₛ is the activity of the solution in the sealed chamber. The activity levels of the ionic solutions are driven by ambient vapor pressure variations. FIG. 4 indicates the vapor pressure change associated with a 40% transient in ambient humidity from 40% to 80% at 30° C. is from 2.0 kPa to 4.25 kPa.

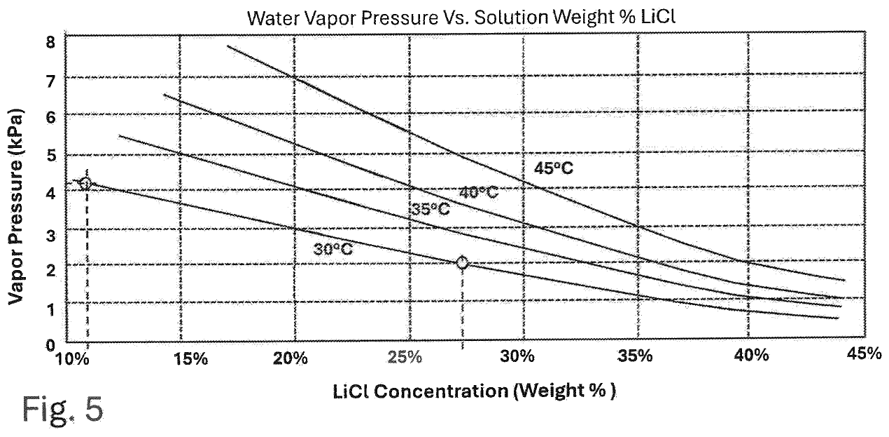

FIG. 5 is a chart of water vapor pressure equilibrium for lithium chloride hygroscopic salt solution versus weight % concentration at 30° C., 35° C., 40° C. and 45° C. As indicated, at 30° C., a transient between 2 kPa and 4.25 kPa represents a solution concentration transient between 27.5% and 11% solution concentration.

A 27.5 weight % concentration of LiCl corresponds to 0.402 moles H₂O per 0.064 moles of LiCl, or 6.4 moles/kg of solution. Similarly, 11 weight % concentration of LiCl corresponds to 0.495 moles H₂O per 0.026 moles LiCl, or 2.6 moles LiCl/kg of solution. A transition from 0.064 moles in solution to 0.026 moles LiCl requires conduction of 0.038 moles or 1.01 kAh of lithium-ion current through the membrane with associated external electron current. A complete daily cycle amounts to 2.02 kAh of current. For two solution reservoirs, 38 moles of lithium ions conducted per kilogram of solution is 1 kAh/kgₛₒₗ, (2.02 kAh/kg/2ₛₒₗ).

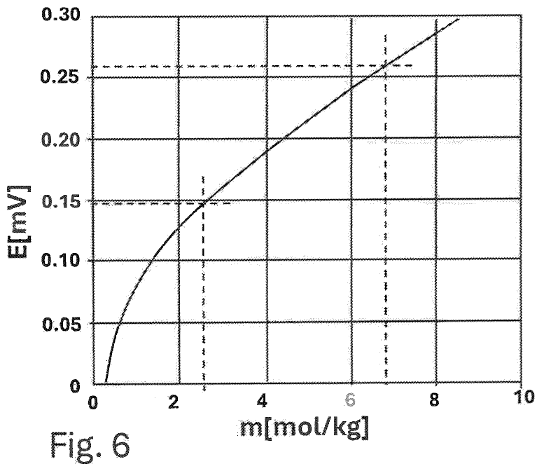

FIG. 6 shows ideal voltage levels for LiCl salt concentration given by Equation 1 using a transference number (t_{c}) of 1 referenced to a concentration of 0.2 moles/kg. A cell driven by ambient humidity transitioning between 40% and 80% at 30° C. ideally generates a daily 0.111 Volt oscillation. Considering the alternating current nature of the power generated, a 111V peak-to-peak voltage equates to an RMS equivalent value of 0.0392V. At 1 kAh/kgₛₒₗ of current per daily cycle amounts to a potential for 39.2 Wh/kgₛₒₗ per day, (0.039V*1 kAh).

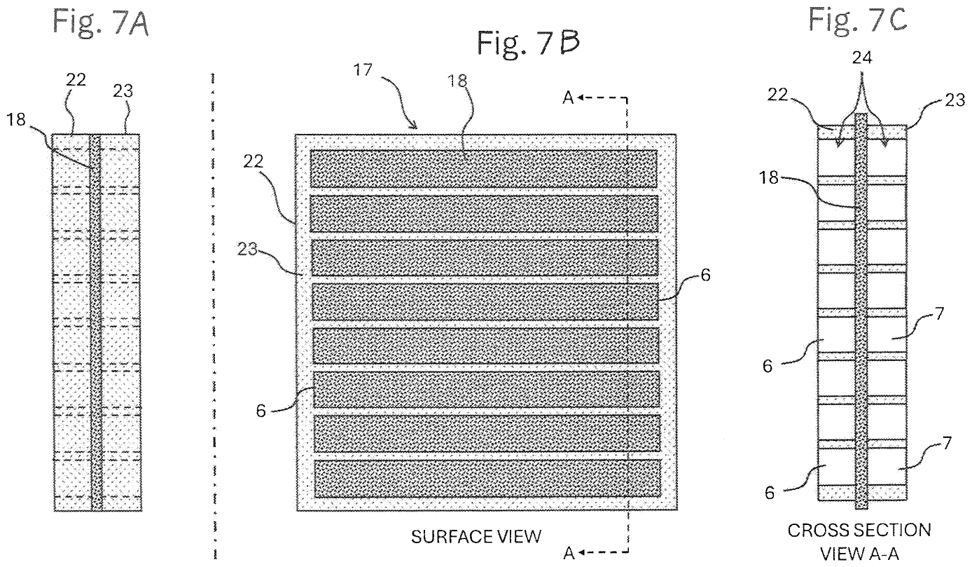

FIGS. 7A-7C illustrate a structure of a self-recharging battery having an array of ion concentration cells 19 in series to generate and store power at useful voltage levels. Conductive barrier electrolyte 18 is sandwiched between a pair of frames 22 and 23, frames 22 and 23 being electrically insulative. Frames 22 and 23 are configured to form an array of electrolyte chamber pairs 24, each electrolyte chamber pair 24 being comprised of a chamber 6 and a chamber 7 with conductive barrier electrolyte 18 sandwiched in between. The illustration includes surface view 17 from one side showing the surface of conductive barrier electrolyte 18 exposed within each chamber. The illustration of FIG. 7C also includes cross sectional view A-A of the structure.

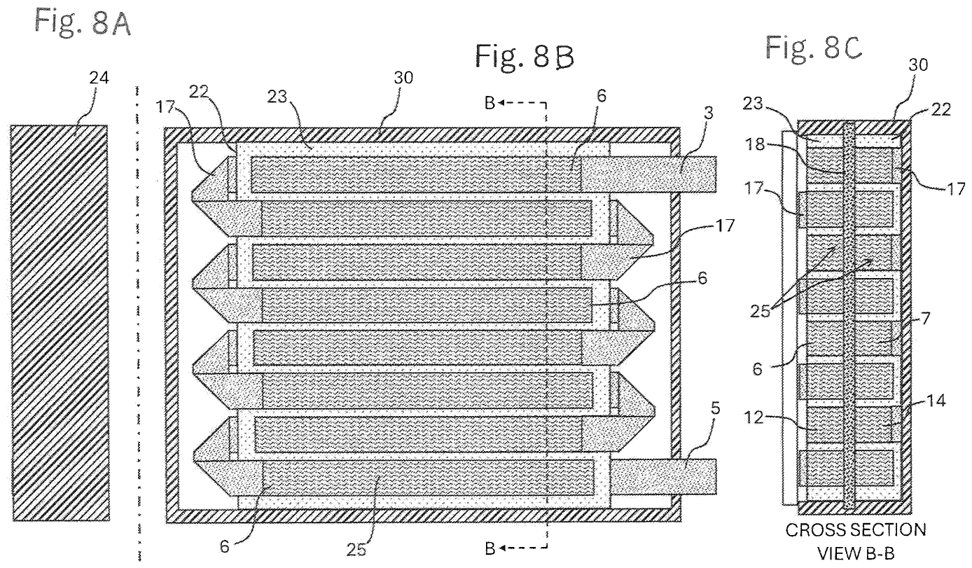

FIGS. 8A-8C show the array of ion concentration cells 19 mounted within a housing 30 and the inclusion of interconnects 17 to sequentially connect opposing pairs of chambers 6 and 7 electrically in series such that terminals 3 and 5 present the sum of the voltages of the cell pairs. A silver-based electrode material 25 is included within each of the chambers along with ionic or hygroscopic electrolyte solutions 12 and 14, particularly with the first electrolyte solution 12 contained in chambers 6 being hygroscopic. The electrolyte solution may be suspended within an electrically conductive wick or gel material that holds the solution in place while providing electrochemical reactivity and electric current conductive continuity throughout the solution. It is understood that the chemical components used as representative examples herein are not intended to be limiting. Other reactions are possible including those involving conductive barriers of ions of other materials including hydrogen, sodium, calcium as well as others and the reduction species within the electrodes may be metals other than silver including iron, lead, cobalt, copper as well as others.

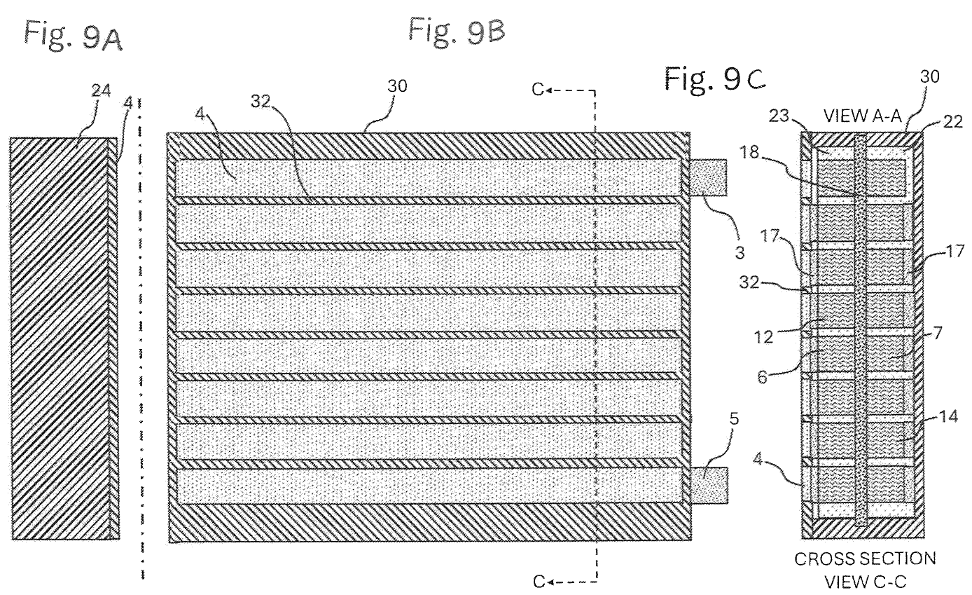

FIGS. 9A-9C show the interconnected chamber pairs assembly mounted inside housing 30 with porous hydrophobic membrane or cover 4 bonded to housing 30 along the external perimeters 32 of individual cells.

Although the foregoing has been a description and illustration of specific embodiments of the subject matter, various modifications and changes thereto can be made by persons skilled in the art without departing from the scope and spirit of the invention.

What is claimed is:

1. An ambient energy converter comprising:
an ion concentration cell that includes a first electrode, a first electrolyte solution, an ion conductive barrier electrolyte, a second electrolyte solution, and second electrode;
the first electrode being in contact with the first electrolyte solution;
the second electrode being in contact with the second electrolyte solution;
the ion conductive barrier electrolyte having a transference number of substantially one;
the first electrolyte solution being in contact with to the ion conductive barrier electrolyte, in contact with the first electrode, and in contact with ambient,
the second electrolyte solution being in contact with the ion conductive barrier electrolyte oppositely disposed from the first electrolyte solution, in contact with to the second electrode, and isolated from ambient;
the first electrolyte solution and the second electrolyte solution having at least one ion species in common;
the barrier electrolyte being an ion conductor of the at least one ion species in common of the first electrolyte solution and the second electrolyte solution, and
the first electrolyte solution being hygroscopic and maintaining a water vapor pressure equilibrium with ambient by absorbing and releasing water vapor to ambient,
whereby the harvesting device generating electrical power by electrochemical reactions between the first and second electrodes and the electrolyte solutions as the ion conductive barrier electrolyte conducts the at least one ion species in common back and forth between the first electrolyte solution and the second electrolyte solution to maintain ion concentration equilibrium between the first electrolyte solution and the second electrolyte solution as the first electrolyte solution absorbs and releases water vapor to and from ambient.

2. The ambient energy converter of claim 1 further comprising a controller electrically coupled to the first electrode and the second electrode and including sensors for monitoring the operating conditions thereof and extracting power when predetermined conditions have been met.

3. The ambient energy converter of claim 1 wherein the ion conductive barrier electrolyte is an inorganic material.

4. The ambient energy converter of claim 1 wherein the ion conductive barrier electrolyte is a metal oxide material.

5. The ambient energy converter of claim 1 wherein the ion conductive barrier electrolyte is a metal phosphate material.

6. The ambient energy converter of claim 1 wherein the first electrode and the second electrodes are silver based electrodes.

7. The ambient energy converter of claim 1 wherein the first electrolyte solution and the second electrolyte solution are both aqueous lithium chloride solutions.

8. The ambient energy converter of claim 1 wherein the ion conductive electrolyte barrier is a lithium super ionic conductor material.

9. The ambient energy converter of claim 1 wherein the ion conductive electrolyte barrier is a sodium super ionic conductor material and the first and second electrolyte solutions include sodium ions.

10. The ambient energy converter of claim 1 wherein the ion conductive electrolyte barrier is a lanthanum zirconium oxide material.

11. The ambient energy converter of claim 1 wherein the ion conductive electrolyte barrier material is lithium aluminum titanium phosphate material.

12. The ambient energy converter of claim 1 wherein the ambient energy converter comprises an array of ion concentration cells electrically connected in series.

13. The ambient energy converter of claim 12 wherein the array of ion concentration cells share a common barrier electrolyte layer.

14. An ambient energy converter comprising:
a first chamber open to ambient air;
a first electrode positioned within the first chamber;
a first electrolyte solution positioned within the first chamber in contact with the first electrode and with ambient air, the first electrolyte solution being hygroscopic and maintaining a water vapor pressure equilibrium with ambient by absorbing and releasing water vapor to ambient;
a second chamber isolated from ambient air;
a second electrode positioned within the second chamber;
a second electrolyte solution positioned within the second chamber in contact with the second electrode;
the first electrolyte solution and the second electrolyte solution having at least one ion species in common;
an ion conductive barrier electrolyte separating the first electrolyte solution within the first chamber from the second electrolyte solution within the second chamber, the ion conductive barrier electrolyte allowing the transfer of the at least one ion species through the ion conductive barrier electrolyte from the first electrolyte solution to the second electrolyte solution and from the second electrolyte solution to the first electrolyte solution, and
whereby the harvesting device generating electrical power by electrochemical reactions between the first and second electrodes and the electrolyte solutions as the ion conductive barrier electrolyte conducts the at least one ion species in common back and forth between the first electrolyte solution and the second electrolyte solution to maintain ion concentration equilibrium between the first electrolyte solution and the second electrolyte solution as the first electrolyte solution absorbs and releases water vapor to and from ambient.

15. The ambient energy converter of claim 14 the ion conductive barrier electrolyte has a transference number of substantially one.

16. The ambient energy converter of claim 14 further comprising a controller electrically coupled to the first electrode and the second electrode and including sensors for monitoring the operating conditions thereof and extracting power when predetermined conditions have been met.

17. The ambient energy converter of claim 14 wherein the ion conductive barrier electrolyte is an inorganic material.

18. The ambient energy converter of claim 14 wherein the ion conductive barrier electrolyte is a metal oxide material.

19. The ambient energy converter of claim 14 wherein the ion conductive barrier electrolyte is a metal phosphate material.

20. The ambient energy converter of claim 14 wherein the first electrode and the second electrodes are silver based electrodes.

21. The ambient energy converter of claim 14 wherein the first electrolyte solution and the second electrolyte solution are both aqueous lithium chloride solutions.

22. The ambient energy converter of claim 14 wherein the ion conductive electrolyte barrier is a lithium super ionic conductor material.

23. The ambient energy converter of claim 14 wherein the ion conductive electrolyte barrier is a sodium super ionic conductor material and the first and second electrolyte solutions include sodium ions.

24. The ambient energy converter of claim 14 wherein the ion conductive electrolyte barrier is a lanthanum zirconium oxide material.

25. The ambient energy converter of claim 14 wherein the ion conductive electrolyte barrier material is lithium aluminum titanium phosphate material.

26. The ambient energy converter of claim 14 wherein the ambient energy converter comprises an array of ion concentration cells electrically connected in series.

27. The ambient energy converter of claim 26 wherein the array of ion concentration cells share a common barrier electrolyte layer.
